(19) United States
(12) Patent Application Publication
(10) Pub. No.: US 2024/0289095 A1
(43) Pub. Date: Aug. 29, 2024

(54) SYSTEM AND METHOD PROVIDING INTERACTION MECHANISM

(71) Applicant: Wix.com Ltd., Tel Aviv (IL)

(72) Inventors: Amir Gabay, Even Yehuda (IL); Nir Domshlak, Petach Tikya (IL); Yaron Orenstein, Tel Aviv (IL); Yasmin Lougassi, Ashdod (IL); Ronny Elkayam, Kiryat Ono (IL); Arthur Vainer, Tel Aviv (IL); Uri Abramson, Tel Aviv (IL)

(21) Appl. No.: 18/583,922

(22) Filed: Feb. 22, 2024

Related U.S. Application Data
(60) Provisional application No. 63/486,497, filed on Feb. 23, 2023.

(51) Int. Cl. G06F 8/20; G06F 8/38; G06F 16/958

(52) U.S. Cl. CPC G06F 8/20; G06F 8/38; G06F 16/986

(57) ABSTRACT

A website building system (WBS) includes at least one processor, and a mid-transition interaction system running on the at least one processor to enable a designer using the WBS, to build a transitional page. The mid-transition interaction system includes at least one database storing designer parameters and parameters of end-users accessing websites and transitional pages created by the WBS, and an input presenter to determine a personalized input mechanism to present at least content to the designer according to least the designer parameters and the parameters of end-users for use with at least one of: a transitional page creator to enable the designer to build the transitional page; and a communicator enabling communication between the designer and at least one end-user.

### CROSS REFERENCE TO RELATED APPLICATIONS

This application claims priority from U.S. provisional patent application No. 63/486,497, filed Feb. 23, 2023, which is incorporated herein by reference.

### FIELD OF THE INVENTION

The present invention relates to website building systems generally and to interactive mechanisms in particular.

### BACKGROUND OF THE INVENTION

Website building systems (WBS) are used by both novices and professionals to create interactive websites. Existing WBSs are based on a visual editing model, and most WBSs typically provide multiple templates, with a template possibly including a complete sample website, a website section, a single page, or a section of a page.

WBS users (also known as designers, subscribers, subscribing users or site editors) may design the website and the website's end-users (the “users of users”) may access the websites created by the users. Although end-users typically access the system in read-only mode, WBSs (and websites) may allow end-users to perform changes to the web site such as adding or editing data records, adding talkbacks to news articles, adding blog entries to blogs etc. The WBS may in fact allow multiple levels of users (i.e., more than two levels), and assign different permissions and capabilities to each level. Users of the WBS (in particular in the full or partial on-line configurations described in more detail herein below) may register with the WBS server which manages the users, their web sites and accesses by the end-users. It will be appreciated that references to designers are generally to specific persons (in the singular), even though the function(s) of designer may be also performed by an organization (or a group of people and/or organization) having multiple roles “within the designer”. Thus, the term “designer” may include (for example) a website owner, one or more actual designers, and one or more website operators (which handle day-to-day operation).

A WBS may be a standalone system or may be embedded inside a larger editing system. It may also be on-line (i.e., applications are edited and stored on a server), off-line or partially on-line (with web sites being edited locally but uploaded to a central server for publishing). The WBS may use an internal data architecture to store WBS based sites and this architecture may organize the handled sites' internal data and elements inside the system. This architecture may be different from the external view of the site (as seen, for example, by the end-users). It is also typically different from the way the HTML pages sent to the browser are organized.

For example, the internal data architecture may contain additional properties for each element in the page (creator, creation time, access permissions, link to templates, SEO (search engine optimization) related information etc.) which are relevant for the editing and maintenance of the site in the WBS but are not externally visible to end-users (or even to some editing users). The WBS may implement some of its functionality (including both editing and run-time functionality) on a server or server set, and some of its functionality on client elements. The WBS may also determine dynamically whether to perform some functionality on the server or on the client platform.

A WBS typically handles the creation and editing of visually designed applications (such as a website) consisting of pages, containers and components. Pages may be separately displayed and contain components. Components may include containers as well as atomic components.

The WBS may also support hierarchical arrangements of components using atomic components (text, image, shape, video etc.) as well as various types of container components which contain other components (e.g., regular containers, single-page containers, multi-page containers, gallery containers etc.). The sub-pages contained inside a container component are referred to as mini-pages, and each of which may contain multiple components. Some container components may display just one of the mini-pages at a time, while others may display multiple mini-pages simultaneously.

The components may be content-less or have internal content. An example of the first category is a star-shape component, which does not have any internal content (though it has color, size, position, attributes, and other parameters). An example of the second category is a text paragraph component, whose internal content includes the internal text as well as font, formatting, and layout information (which is also part of the content rather than being attributes of the component). This content may, of course, vary from one instance of the text paragraph component to another. Components which have content are often referred to as fields (e.g., a “text field”).

Pages may use templates, general page templates or component templates. Specific cases for templates include the use of an application master page containing components replicated in all other regular pages, and the use of an application header or footer (which repeat on all pages). Templates may be used for the complete page or for page sections. The WBS may provide inheritance between templates, pages, or components, possibly including multi-level inheritance, multiple inheritance and diamond inheritance (i.e., A inherits from B and C and both B and C inherit from D).

The visual arrangement of components inside a page is called a layout. The WBS may also support dynamic layout processing, a process whereby the editing of a given component (or other changes affecting it such as externally driven content change) may affect other components, as further described in U.S. Pat. No. 10,185,703 entitled “Website Design System Integrating Dynamic Layout and Dynamic Content” granted 22 Jan. 2019, commonly owned by the Applicant and incorporated herein by reference. It describes how a website may be created based on visual editing or automatic generation based on collected business knowledge.

A WBS may be extended using add-on applications such as a third party application and its components (TPAs), list applications (such as discussed in US Patent Publication No. US 2014/0282218 entitled “WBS Integrating Data Lists with Dynamic Customization and Adaptation” published 18 Sep. 2014, commonly owned by the Applicant and incorporated herein by reference) and WBS configurable applications (WCAs, such as described in US Patent Publication No. 2020/0151226 entitled “System And Method for Creation and Handling of Configurable Applications for Website Building Systems” published 14 May 2020 commonly owned by the Applicant and incorporated herein by reference). These third party applications and list applications may be added and integrated into designed websites.

Such third party applications and list applications may be purchased (or otherwise acquired) through a number of distribution mechanisms, such as being pre-included in the WBS design environment, from an Application Store (integrated into the WBS's market store or external to it) or directly from the third party application vendor.

The third party application may be hosted on the WBS vendor's own servers, the third party application vendor's server or on a 4th party server infrastructure.

Typical site creation may be based on a number of models, including a visual editing model (in which the user edits a previously created site) and an automatic site generation model or a combination thereof as illustrated in FIG. 1 to which reference is now made and is described in U.S. Pat. No. 10,073,923 entitled “System and Method for the Creation and Update of Hierarchical Websites Based on Collected Business Knowledge” granted 11 Sep. 2018, commonly owned by the Applicant and incorporated herein by reference.

It will be appreciated that throughout the specification, the acronym WBS may be used to represent a website building system. FIG. 1 illustrates a system 100 that comprises a typical WBS 2 in communication with client systems operated by WBS vendor staff 61, a site designer 62 (i.e., a user), a site user 63 (i.e., user of user) and with external systems 70. WBS 2 may further comprise a WBS site manager 10, an object marketplace 15, a WBS RT (runtime) server 20, a WBS editor 30, a site generation system 40 and a WBS content management system (CMS) 50.

In the visual editing model, the user (designer) edits a site based on one or more website templates. The WBS provider may provide multiple site (or other) templates, with each template possibly including a complete sample web site, a web site section, a single page or a section of a page. Users may have the option to start with an empty site (essentially a “blank page” template) but would typically start with an actual site template.

WBS site manager 10 may be used by the site designer to manage his created sites (for example to handle the payment for the site hosting or set permissions for site access).

Object marketplace 15 may allow for the trading of objects (such as add-on applications, templates, and element types) between object vendors and site designers through the system.

WBS RT (runtime) server 20 may handle the run-time access by (possibly numerous) site viewers. Such access may be read-only but may also involve interactions that may affect back-end data or front-end display (such as purchasing a product or posting a comment on a blog). In some embodiments of the system, the MTIS Runtime server may also serve pages to site designers (e.g., when previewing the site, or as a front-end to the editor).

WBS editor 30 may allow site designers to edit site pages (manually or automatically generated), including the editing of content, logic, layout, and attributes. Thus, it may allow site designers to adapt a particular template and its elements according to their business or industry.

Site generation system 40 may create the actual site based on the integration and analysis of information entered by the site designer (via questionnaires, templates, etc.), pre-specified and stored in content management system (CMS) 50 together with information from external sources and internal information held within the CMS 50 that may be gleaned from the use of the system by other designers. In an alternative embodiment, CMS 50 may be held in centralized storage or locally by the site designer.

The WBS provider may provide site templates ranging from the very generic (e.g., mobile site, e-store) through the more specific (e.g., law office, restaurant, florist) to the highly specific ones (e.g., a commercial real-estate law office or a Spanish tapas restaurant). Such templates are typically stored in a repository accessible to users of the WBS and are typically classified according to business type, sub-type or industry. Templates may also be created (and classified) according to style, color range or other parameters and not just according to business type. Site templates may be extended with additional (typically back-end) functionality, services and programming code in order to become full-fledged vertical solutions integrated with the WBS.

Thus, the user's first experience when creating a site using a WBS visual editor may typically be that the user chooses a template (e.g., according to style or industry type/sub-type), possibly a blank template and then edits the template in the visual editor including the editing of content, logic, layout, and attributes. Such editing may include (in particular) adapting the template and its elements to the details of the user's business. The user may then publish the modified site.

Under the site generation model, the WBS generates an initial site for the user, based on a selected template, possibly modified by filling in common elements of information, and possibly allowing follow-up editing of the generated site. This filling-in is required as various pieces of information (such as the business name or a description of the management team) are included in multiple locations in the template's pages. Thus, the user may have to change the business name (for example) in multiple places throughout the template.

Furthermore, some template elements (e.g., a generic product page) may appear multiple times, with each instance displaying the details of a different instance of an underlying entity (e.g., different products offered on the site, services etc.). Such multiple instances may be manually specified (e.g., the details of different persons in the company's management team) or dynamically derived from an external database (e.g., product details from the “products on sale” database). Such an arrangement is often known as a “repeater.”

The WBS may also display a series of views or questionnaires to allow the user to enter values or selections (for both the defined fields and the additional information above). The WBS may further create a connection (or binding) between a multiple-instance element of the template (as described herein above) and an internal or external database which provides the data instances used to generate the displayed instances.

Once a template has been selected and its fields and additional information have been specified (e.g., through the questionnaires or through binding to data sources), the WBS may generate the website containing the combined information. The user may then publish the site (through the WBS or otherwise).

A WBS may also perform semi-automatic site creation using a different model as described in U.S. Pat. No. 10,073,923. Under this model, the system gathers information on the user and his web site requirements from multiple sources which may include, for example: user-filled questionnaires; existing user presence (such as existing web sites or social media presence), industry sources (such as general trade web sites), off-line information and internal system repositories which provide information on specific business types, such as basic template information for specific business types (lawyers, restaurants, plumbers, graphic designers etc.), possibly refined for specific industries (e.g., distinguishing between real-estate lawyers and personal injury lawyers).

The WBS may also gather external information from other sites, both internal and external to the WBS. Such information may affect, for example, the selection of offered questionnaires and layout elements, proposed defaults etc. Such information may also typically be collected on a statistical or summary basis, in order not to expose information belonging to any single user, and protect users' privacy, anonymity and legal rights (such as copyrights). Such information may be located based on information provided by the user which may be direct (e.g., an existing website address) or indirect (a business name and geographical address which can be used to locate information about the business). It will be appreciated that collected business knowledge refers to the collection of relevant content to the website being created which may be gleaned from external systems or other sources (as described in U.S. Pat. No. 10,073,923).

The gathered information is analyzed and arranged into a repository of content elements which are then mapped onto layout elements which present the content from the content elements and combine the layout elements to form the site. The layout element mapping, selection and combination process may be fully automatic or semi-automatic (i.e., including user interaction).

To support the above mentioned functionality above, a WBS may typically maintain a series of repositories (which may form CMS 50), stored over one or more servers or server farms. Such repositories may typically include various related repositories such as a user information/profile repository, a WBS (WBS) component repository, a WBS site repository, a Business Intelligence (BI) repository, an editing history repository, a third party application store repository, etc. The system may also include site/content creation related repositories such as a questionnaire type repository, a content element type repository, a layout element type repository, a design kit repository, a filled questionnaires repository, a content element repository, a layout element repository, a rules repository, a family/industry repository etc. A description of these repositories may be found in U.S. Pat. No. 10,073,923.

Many social networks tend to be self-contained and do not present their users with many options for branching out of their system. This may be done, for example, by preventing the embedding of links inside social media posts or limiting the poster to a single link. The social network may also limit the user to what can be done in his or her post, e.g., not allowing embedding of video from external platforms (or at all). The social network providers have a clear business justification for keeping the users in their system and presenting them with the services including monetization services. However, the users (designers in this context) may want more functionality, possibly including the ability to redirect their users (fans in this context) to multiple destinations and provide richer content to their fans. The designer may also want to embed specific technologies (such as embedding programming code in page) which the social network does not allow in its pages.

A solution to this is link in bio pages, also known as intermediate pages or transitional pages. Most social media platforms provide the option to add a link in a personal bio to take followers to a transitional page with a listing of links to other pages and services. This can drive traffic from different social profiles to valuable content.

### SUMMARY OF THE PRESENT INVENTION

There is provided, in accordance with a preferred embodiment of the present invention, a website building system (WBS). The system includes at least one processor, and a mid-transition interaction system running on the at least one processor to enable a designer using the WBS to build a transitional page. The mid-transition interaction system includes at least one database storing designer parameters and parameters of end-users accessing websites and transitional pages created by the WBS, and an input presenter to determine a personalized input mechanism to present at least content to said designer according to least the designer parameters and the parameters of end-users for use with at least one of: a transitional page creator to enable the designer to build a transitional page, and a communicator enabling communication between the designer and at least one end-user.

Moreover, in accordance with a preferred embodiment of the present invention, the input presenter dynamically changes the presentation of the personalized input mechanism according to changing context of at least one of: the transitional page and the communication.

Further, in accordance with a preferred embodiment of the present invention, the designer parameters comprise at least one of: designer editing history, designer search history, designer websites and previously created and shared links, products, videos and services.

Still further, in accordance with a preferred embodiment of the present invention, the input presenter enables toggling between the display of the personalized input mechanism and display of the regular input mechanism of the designer.

Additionally, in accordance with a preferred embodiment of the present invention, the parameters of end-users include usage behavior of end-users using the websites and transitional pages.

Moreover, in accordance with a preferred embodiment of the present invention, the at least one end-user parameters are tracked using at least one of: cookies, device fingerprints, mobile advertising IDs, universal IDs and contextual targeting.

Further, in accordance with a preferred embodiment of the present invention, the at least content includes at least one of: a link, a product, a video, a service, other entities previously created by the designer and assets and resources external and internal to the WBS.

Still further, in accordance with a preferred embodiment of the present invention, the at least one database also stores transitional entities such as products and services, campaigns, coupons and advertisements for presentation by the input presenter.

Additionally, in accordance with a preferred embodiment of the present invention, the mid-transition interaction system further includes an analyzer to at least analyze designer parameters and parameters of end-users to provide recommendations for content for the transitional page and the communicator using at least one of: heuristics, statistical analysis, artificial intelligence and training a machine learning model or a combination thereof to determine the recommendations, a campaign/coupon handler to determine campaigns and coupons for display on the transitional page according to the analyzer and systems external to the system; and a search box handler to determine what content can be presented to the at least one end-user of the transitional page for end-user searching purposes.

Moreover, in accordance with a preferred embodiment of the present invention, the analyzer includes an AI/ML (artificial intelligence/machine learning) engine to at least provide the artificial intelligence and to train at the machine learning model; and a recommender to make recommendations to the input presenter according to the output of the AI/ML engine.

Further, in accordance with a preferred embodiment of the present invention, the personalized input mechanism is a keyboard.

Still further, in accordance with a preferred embodiment of the present invention, the personalized input mechanism is controlled by predefined snippets of programming code defining at least one of: previously displayed links, products, videos, service or entities by the designer, an API use to change the UI for the designer or at least one the end-user, custom code for use by the designer, addition of mechanisms and frameworks external to the WBS for use, prompts and use of a generative AI (artificial intelligence system).

Additionally, in accordance with a preferred embodiment of the present invention, the snippets are pre-defined by the WBS vendor or by the designer and are displayed for selection by the designer or end-user to run when the personalized input mechanism is initializing.

There is provided, in accordance with a preferred embodiment of the present invention a system. The system includes at least one processor, and a unit running on the at least one processor to enable a designer to build a transitional page. The unit includes a transitional page creator to enable the designer to create the transitional page made up of at least one feature according to recommendations and designer added links, and an input presenter to determine and present a personalized input mechanism for the designer when using the transitional page creator according to at least one of: previously created and shared links, products, videos and services by the designer, and where the input presenter dynamically changes the presentation of the personalized input mechanism according to changing context of the transitional page.

Moreover, in accordance with a preferred embodiment of the present invention, the at least one feature includes at least one of: an advertisement, a coupon, a campaign, a header, a specialty button, an action and a search box.

Further, in accordance with a preferred embodiment of the present invention, the specialty button is a skip button for an end-user to bypass the transitional page.

Still further, in accordance with a preferred embodiment of the present invention, the system is integrated with a website building system.

Additionally, in accordance with a preferred embodiment of the present invention, the action is at least one of: monetizing and promotional.

There is provided, in accordance with a preferred embodiment of the present invention, a method for a website building system (WBS). The method includes enabling a designer of the WBS to build a transitional page; the enabling a designer of the WBS to build a transitional page including: storing in at least one database designer parameters and parameters of end-users accessing websites and transitional pages created by the WBS, and determining a personalized input mechanism to present at least content to the designer according to least the designer parameters and the parameters of end-users for use with at least one of: enabling the designer to build a transitional page, and enabling communication between the designer and at least one end-user.

Moreover, in accordance with a preferred embodiment of the present invention, the determining a personalized input mechanism dynamically changes the presentation of the personalized input mechanism according to changing context of at least one of: the transitional page and the communication.

Further, in accordance with a preferred embodiment of the present invention, the designer parameters include at least one of: designer editing history, designer search history, designer websites and previously created and shared links, products, videos and services.

Still further, in accordance with a preferred embodiment of the present invention, the determining a personalized input mechanism enables toggling between the display of the personalized input mechanism and display of the regular input mechanism of the designer.

Additionally, in accordance with a preferred embodiment of the present invention, the parameters of end-users comprise usage behavior of end-users using the websites and transitional pages.

Moreover, in accordance with a preferred embodiment of the present invention, the end-user parameters are tracked using at least one of: cookies, device fingerprints, mobile advertising IDs, universal IDs and contextual targeting.

Further, in accordance with a preferred embodiment of the present invention, the at least content includes at least one of: a link, a product, a video, a service, other entities previously created by the designer and assets and resources external and internal to the WBS.

Still further, in accordance with a preferred embodiment of the present invention, the storing in at least one database also stores transitional entities such as products and services, campaigns, coupons and advertisements for presentation by the determining a personalized input mechanism.

Additionally, in accordance with a preferred embodiment of the present invention, the enabling the designer to build a transitional page further includes at least analyzing designer parameters and parameters of end-users to provide recommendations for content for the transitional page and the communicator using at least one of: heuristics, statistical analysis, artificial intelligence and training a generative machine learning model or a combination thereof to determine the recommendations; determining campaigns and coupons for display on the transitional page according to the at least analyzing and systems external to the WBS, and a search box handler to determine what content can be presented to the at least one end-user of the transitional page for end-user searching purposes.

Moreover, in accordance with a preferred embodiment of the present invention, the analyzing designer parameters and parameters of end-users includes at least providing artificial intelligence and training of at least one machine learning model; and making recommendations for the determining a personalized input mechanism according to the output of the at least providing artificial intelligence and training of the machine learning model.

Further, in accordance with a preferred embodiment of the present invention, the personalized input mechanism is a keyboard.

Still further, in accordance with a preferred embodiment of the present invention, the method includes controlling the personalized input mechanism using predefined snippets of programming code defining at least one of: previously displayed links, products, videos, service or entities by the designer, an API use to change the UI for the designer or the end-user, custom code for use by the designer, addition of mechanisms and frameworks external to the WBS for use, prompts and use of a generative AI (artificial intelligence system).

Still further, in accordance with a preferred embodiment of the present invention, the method includes pre-defining the snippets, and displaying the snippets for selection by the designer or end-user to run when the personalized input mechanism is initializing.

There is provided, in accordance with a preferred embodiment of the present invention, a method. The method includes enabling a designer to build a transitional page; the enabling includes enabling the designer to create the transitional page including at least one feature according to recommendations and designer added links; and determining and presenting a personalized input mechanism for the designer when creating the transitional page according to at least one of: previously created and shared links, products, videos and services by the designer; and where the determining and presenting dynamically changes the presentation of the personalized input mechanism according to changing context of the transitional page.

Moreover, in accordance with a preferred embodiment of the present invention, the at least one feature includes at least one of: an advertisement, a coupon, a campaign, a header, a specialty button, an action and a search box.

Further, in accordance with a preferred embodiment of the present invention, the specialty button is a skip button for an end-user to bypass the transitional page.

Still further, in accordance with a preferred embodiment of the present invention system is integrated with a website building system.

Additionally, in accordance with a preferred embodiment of the present invention the action is at least one of: monetizing and promotional.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a representation of a website building system of the prior art;

FIG. 2 is a schematic illustration of a transitional page of the prior art;

FIG. 3 is schematic illustration of a website building system with an integrated mid transition interaction system, constructed and operative in accordance with the present invention;

FIG. 4 is a schematic illustration of the elements of the integrated mid transition interaction system of FIG. 3, constructed and operative in accordance with the present invention;

FIG. 5 is a schematic illustration of a transitional page; constructed and operative in accordance with the present invention;

FIG. 6 is a screen shot of a transitional page; constructed and operative in accordance with the present invention;

FIG. 7 is schematic illustration of an example input mechanism for a designer using the system of FIG. 3, constructed and operative in accordance with the present invention;

FIGS. 8A, 8B and 8C are schematic illustrations of example scenarios of communication by a designer using the system of FIG. 3 and his end-users and the presentation of a personalized input mechanism, constructed and operative in accordance with the present invention.

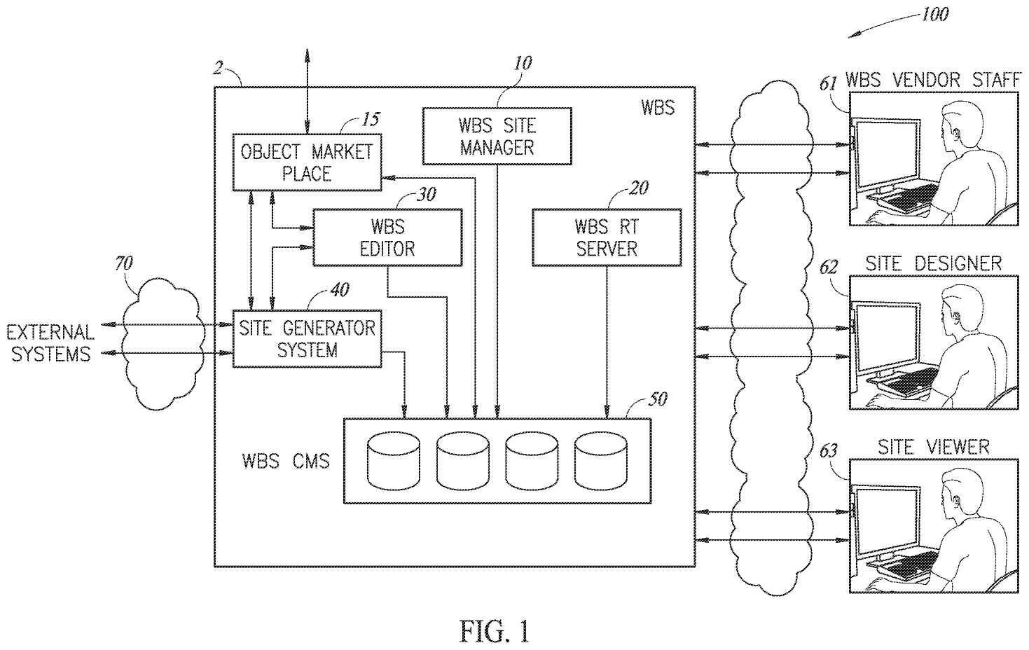

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that website building systems as described herein above, also need to provide their users or designers with the ability to create and publish bio links/transitional pages. Furthermore, designers of bio links/transitional pages could benefit from the integration and use of the services provided by a website building system. Applicant has further realized that although this capability exists in the prior art, there is a need to make the creation of transitional pages more personalized, more efficient and less time consuming.

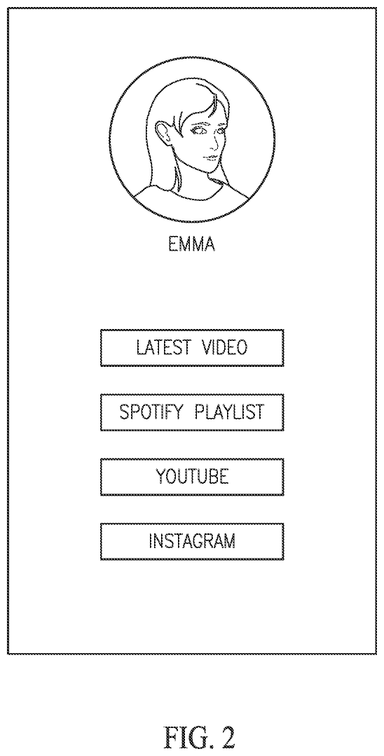

As discussed herein above, transitional pages of the prior art are typically a list of links on a page as illustrated in FIG. 2 to which reference is now made. Applicant has further realized that this capability may also be extended to the creation of transitional pages that also present (for example) landing pages, menus, search pages, and other types of interactive elements as described in more detail herein below. Such pages may be inserted “in the middle” of a transition (e.g., a transition affected by pressing a hyperlink) and provide mid-transition interaction with an end-user, while allowing the page creator to manage these transitions.

Furthermore, Applicant has also realized that creation of a transitional page may further comprise the ability to understand its end-users and store usage and behavior information about them. For example, a page may also comprise a “skip” button for an end-user to exit the transitional page and continue to the destination URL, a time out functionality for the display of the transitional page or may even recognize that the end-user has previously “skipped” a particular transitional page and may create and display transitional pages accordingly.

A WBS stores its designer information and parameters such as previous editing history of sites they have built, online/offline searches, previous links they have used etc. The applicant has also realized that this information could be harnessed to provide recommendations for materials for the transitional page. The WBS may also store end user activity according to his history of end user activity on websites and transitional pages built using the WBS.

Applicant has further realized that features may be added to the creation of transitional pages by designers and to the use of transitional pages such as a personalized input method such as a keyboard. Such features may make the creation and use of transitional pages efficient and user friendly. The input mechanism, which may be in the form of a keyboard like mechanism, may automatically offer a designer links to add to his transitional page based on his editing history, searches etc. Alternatively, it may provide recommendations for a designer to send to his end-users based on conversation content from a communication medium between the conversing parties.

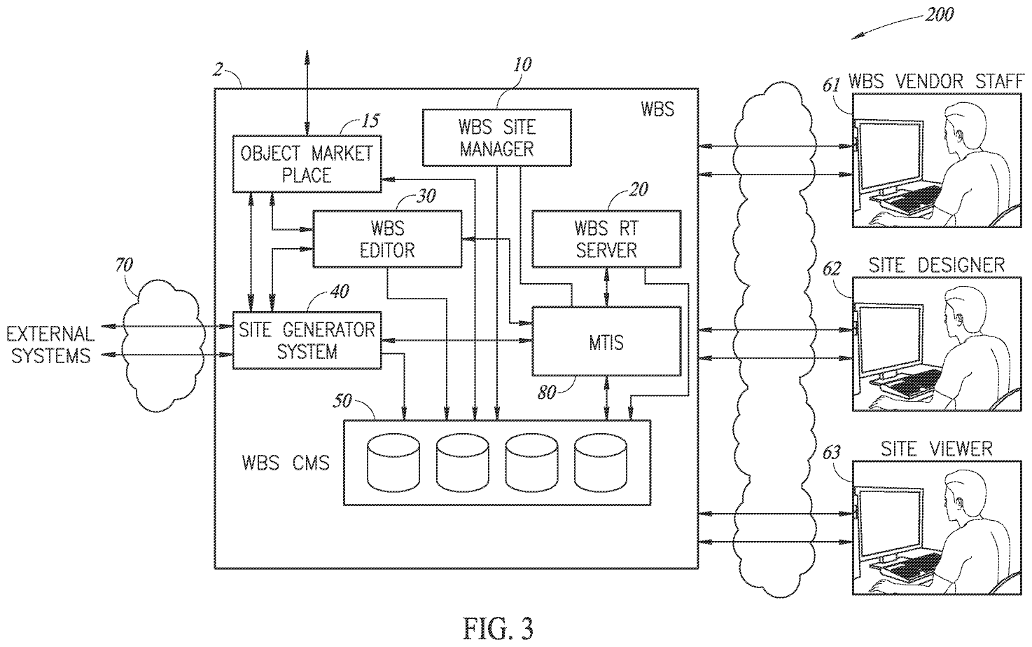

Reference is now made to FIG. 3 which illustrates a WBS 200 comprising a mid-transition interaction system (MTIS) 80 for the creation and generation of transitional pages according to an embodiment of the present invention. System 200 may comprise the elements of system 100 as described in U.S. Pat. No. 10,073,923 (as well as any sub elements) in conjunction with MTIS 80. In an alternative embodiment, MTIS 80 may be standalone or may function as online (i.e., applications are edited and stored on a server or server set), offline, or partially online (with websites being edited locally but uploaded to a central server for publishing) system.

It will be appreciated that MTIS 80 may assist a website designer scale up their brands and business by enabling them to build a tailored transitional page. MTIS 80 may offer innovative services, all of which rely on online WBS users (designers) sharing links. In particular, MTIS 80 functionality may be adapted to the creation and access of these services from a UI operating on a mobile or other small-form-factor platforms, which is becoming increasingly popular.

It will be appreciated that MTIS 80 users also may also be referred to as designers, creators, subscribers, subscribing users or site editors, and code editors, which are the ones designing the websites, as well as to end-users which are the “users of users”, accessing the web sites created by the users (and may also be referenced to as “fans” of the “creator” such as an artist or performer) and the pages displayed by MTIS 80 (even if not in the context of a website). Although end-users typically access the system in read-only mode, MTIS 80 may allow end-users to perform changes to websites, such as adding or editing data records, adding talkbacks to news articles, adding blog entries to blogs, adding emojis as a reply, adding comments, etc. MTIS 80 may allow multiple levels of designers (i.e., more than two levels), and may assign different permissions and capabilities to each level.

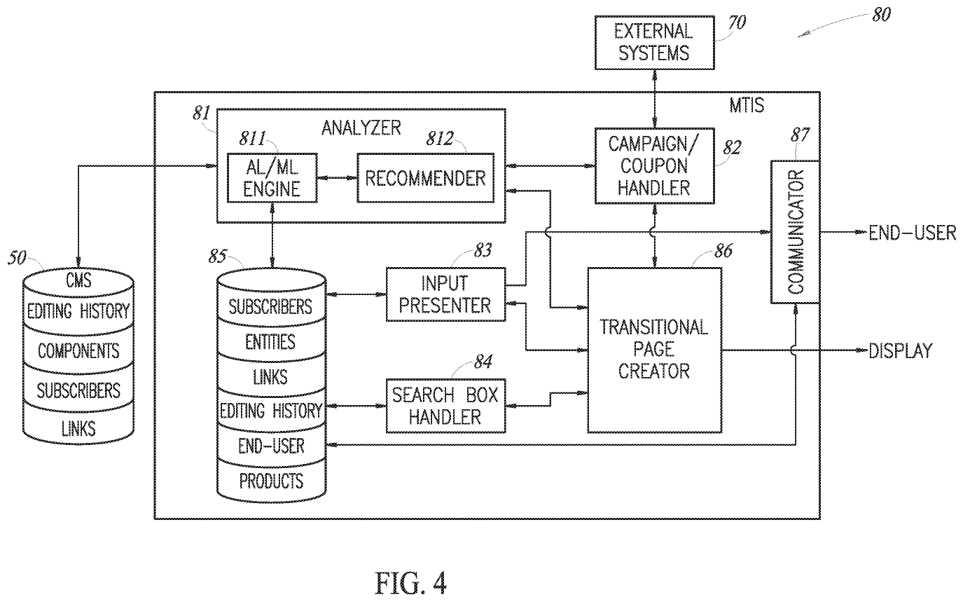

Reference is now made to FIG. 4 which illustrates the elements of MTIS 80. MTIS 80 may further comprise an analyzer 81, a campaign/coupon determiner 82, an input presenter 83, a search box handler 84, an MTIS database 85, a transitional page creator 86 and a communicator 87. Analyzer 81 may further comprise an Artificial Intelligence (AI)/Machine Learning (ML) engine 811 and a recommender 812.

Designers using MTIS 80 (in the full or partial online configurations) may typically be registered as subscribers with the WBS. Their information such as websites and components, editing history, searches and accesses by end-users etc. may be stored in CMS 50. In an alternate embodiment the information may be stored in database 85. Database 85 may further store transitional page information and other entities such as products and services, their links, and their parameters as well as campaign parameters, information and parameters about end users, their usage behavior and other input parameters as described in more detail herein below.

Analyzer 81 may analyze designer information held in CMS 50 and/or database 85 such as editing history, designer search history, designer websites, end-user behavior etc. and other transitional pages and links in order to make decisions about the presentation materials for transitional page creator 86 and decisions for other elements of MTIS 80.

Analyzer 81 may use mechanisms such as heuristics, statistical analysis, AI/ML engine 811, or by training a generative ML model (like models such as ChatGPT) or a combination of any of these mechanisms to provide recommendations and recommender 812 may provide this information to transitional page creator 86 to present to a designer who is creating a transitional page.

AI/ML engine 811 may use generative AI based algorithms for proposing assets/resources to designers according to information on other designers internal and external to WBS 200 (and subject to all relevant laws, regulation, and IP and other property rights). AI/ML engine 811 may further provide train machine learning models to provide support for the functionality of the other elements of MTIS.

It will be appreciated that the terms “trained machine learning model,”“machine learning model,”“model,” or “one or more models” refer to a machine learning or deep learning task or mechanism. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fitted or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). In some embodiments, the model can be trained and/or trained in real-time (e.g., online training) while in use.

The machine learning models, one or more models, trained machine learning models, legitimacy prediction models, improper dispute prediction models, resource volume prediction models, and disputed network transaction prediction models as described above may make use of multiple ML engines, e.g., for analysis, recommendation generating, transformation, and other needs.

AI/ML engine 811 may train different ML models for different needs and different ML-based engines. AI/ML engine 811 may generate new models (based on gathered training data) and may evaluate their performance against the existing models. Training data may include any of the gathered information, as well as information on actions performed based on the various recommendations.

The ML models may be any suitable model for the task or activity implemented by each ML-based engine. Machine learning models are known in the art and are typically some forms of neural network. The term refers to the ability of systems to recognize patterns based on existing algorithms and data sets to provide solution concepts. The more they are trained, the greater knowledge they develop.

The underlying ML models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders, transformer-based), models combining planning with other models (e.g., PDDL-based), or Generative models (e.g., GANs, diffusion-based models).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks, diffusion-based or auto-encoders) to generate definitions and elements.

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein.

In various embodiments and when appropriate for the particular task, one or more of the ML models may be implemented with rule-based systems, such as an expert system or a hybrid intelligent system that incorporates multiple AI techniques.

A rule-based system is used to store and manipulate knowledge to interpret information in a useful way. It is often used in artificial intelligence applications and research. Rule-based systems constructed using automatic rule inference, such as rule-based machine learning, may be included in this system type. An example rule-based system is a domain-specific expert system that uses rules to make deductions or choices. For example, an expert system might help a doctor choose the correct diagnosis based on a cluster of symptoms or select tactical moves to play a game. Rule-based systems can be used to perform lexical analysis to compile or interpret computer programs, or in natural language processing. Rule-based programming attempts to derive execution instructions from a starting set of data and rules.

A hybrid intelligent system employs, in parallel, a combination of methods and techniques from artificial intelligence subfields, such as: neuro-symbolic systems, neuro-fuzzy systems, hybrid connectionist-symbolic models; fuzzy expert systems; connectionist expert systems, evolutionary neural networks, genetic fuzzy systems, rough fuzzy hybridization, and/or reinforcement learning with fuzzy, neural, or evolutionary methods as well as symbolic reasoning methods.

An example hybrid is a hierarchical control system in which the lowest, reactive layers are sub-symbolic. The higher layers, having relaxed time constraints, are capable of reasoning from an abstract world model and performing planning. Intelligent systems usually rely on hybrid reasoning processes, which include induction, deduction, abduction, and reasoning by analogy.

It will be appreciated that analyzer 81 may also be able to determine financial considerations for display on transitional pages such as discounts on promotions and may also filter up-to date discounts, compare their worth etc. for presentation on a transitional page so that end-users may determine which designers provide the best discount for their products.

It will also be appreciated that MTIS 80 may also generate a personalized experience for an end-user by tracking past behavior using cookies and other end-user identifying means such as device fingerprints, mobile advertising IDs, universal IDs, and contextual targeting. For example, if an end-user has skipped a transitional page offering a specific promotion (single or multiple actions) that was not relevant for him in the past, the next time he interacts with a transitional page (from the same designer), he may be offered a different promotion as suggested by recommender 812 or manually by the designer. The past behavior information may also be stored in database 85.

Campaign/coupon determiner 82 may determine and retrieve suitable coupons, advertisements, campaigns, promotions etc. to be presented on the transitional page according to the output of analyzer 81 and from sources internal and external to WBS 200.

Input presenter 83 may determine materials and context to be presented to a designer when building his transitional page and may replace the standard input means of transitional page creator 86 with a personalized input mechanism accordingly as described in more detail herein below. Input presenter 83 may further provide an alternative input mechanism to a designer when communicating with an end-user as described in more detail herein below.

Transitional page creator 86 may use information as supplied by analyzer 81 and campaign/coupon determiner 82 to offer and enable a designer to build his transitional page by displaying a personalized input mechanism supplied by input presenter 83 as discussed in more detail herein below.

It will be appreciated that a transitional page creator 86 may be a specialized editor and may engage with the designer through a dedicated user interface (UI) to help the designer build his transitional page by adding form and content (such as actions, advertisements, and coupons) and providing recommendations as discussed in more detail herein below.

As discussed herein above, a transitional page (also known as a pre-roll) displays monetizing and/or a promotional page of links before taking the end-user to his destination once he has clicked on a URL. It may allow designers to place a virtual billboard in front of their fandom and utilize the new valuable traffic source going through their shared links. The pre-roll is displayed as part of the transition to an original destination. A sample destination could be (for example) an outbound link to an article, video, blog post, music, podcast, or a social post that is hosted on an external website (different domain) or on a different social network or on the same social network.

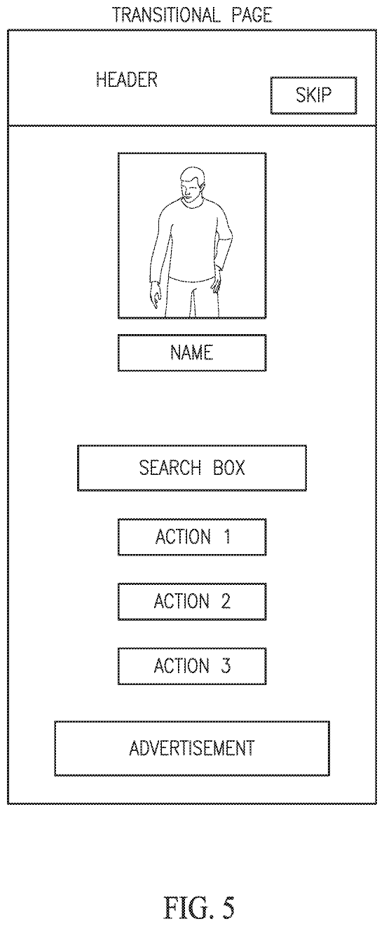

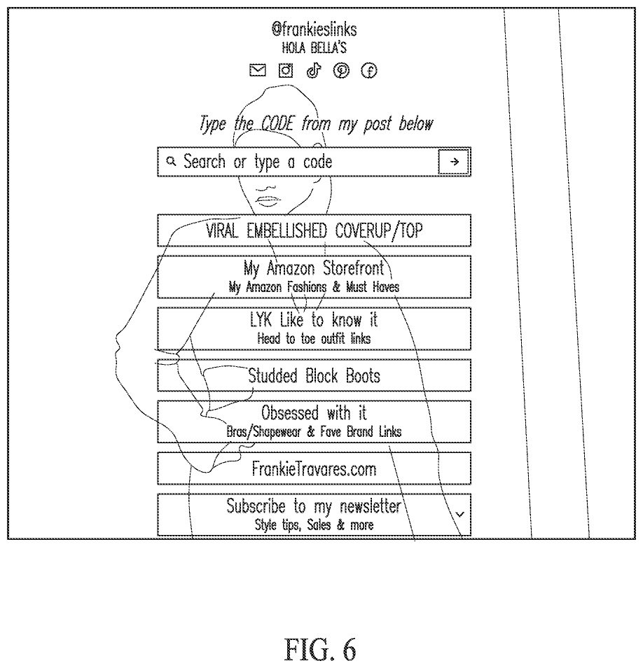

Reference is now made to FIG. 5 which illustrates a schematic version of an exemplary pre-roll. The pre-roll may comprise of a short link to be embedded into the pointing-to page (e.g., a social media post that leads to the pre-roll) and an intermediate landing page. Instead of redirecting to the original destination, (which may have a longer URL), as done by other URL shortening services, MTIS 80 may provide a shorter URL that points to the intermediate landing page. Reference is also made to FIG. 6 which illustrates a screen shot of an example pre-roll.

A pre-roll may comprise a header. The header may present a skip button which may take an end-user straight to his destination if he wants to bypass the transitional page. In an alternative embodiment, the skip functionality may be set to automatic to transfer the end user to his destination after a certain amount of time has passed. In other embodiments, other kinds of buttons may be presented for different actions.

The body of the transitional page may further include a profile picture with a title followed by actions. Actions may be considered components (like a widget) that a designer can choose to use to promote his/her different initiatives. An example is a promotion action such as link, event, service, product, social network, coupon, outfit, share content, music, podcast, blog post, video, image, contact form and membership platform.

Another example is a monetizing action where clearing, processing and other kinds of monetizing related processes are done by either a 3rd party provider (such as Stripe or PayPal) or by the WBS vendor (e.g., through modules for donation, service, digital product, paywall content and merchandise).

It will be appreciated that the links copied and created for the landing pages and/or websites may have properties such as type which may define the link's destination such as product/service/blog/music/podcast/image/event etc.

Another property may be coupon code (such as vouchers, or discount codes)/link shortcuts. The coupon codes may be shared using mechanisms such as description text or visual graphics (such as stickers on Instagram and TikTok), video/audio on any platform such as TikTok, Instagram, YouTube Shorts, Podcasts, TV, or radio and direct the viewers/followers/listeners to type the coupon code in a search. By doing so, the end user may be redirected to the specific destination or action.

Yet another property may be the use of programming code. This may allow designers to share code snippets or sections which use JavaScript, API calls, and other kind of programming languages, utilizing events coming from system 200 (if any). An example may be a timer which starts timing when a designer starts to interact with the input mechanism and presents a question or notice or an advertisement after a certain period of time. By doing so, the end user is redirected to a specific destination or action. These snippets of code may control the way the input mechanism behaves as described in more detail herein below.

Yet another property may be tags such as a keyword or a term assigned to a piece of information. This kind of metadata may help describe an item and allow it to be found again by browsing or searching.

Pre-roll ads (advertisements) are a specific use case of a pre-roll or transitional page. In this scenario, the pre roll page (i.e., the intermediate landing page), displays an advertisement instead of an action.

The advertisement could be (for example) a video from an internet ad server (3rd party or owned), an uploaded video by the designer, a streamed video from an external platform (TikTok/YouTube/Instagram/Twitch or otherwise) or an image or any interactable object.

As discussed herein above, the pre-roll may have a skip button or other type of action button. It will be appreciated that the skip functionality may also be applied to the advertisement. The designer may define a minimum time until the skip button is enabled/displayed (allowing end-users to skip the advert. The skip may be manual or automatic.

The pre-roll may further comprise a search box for an end user as discussed in more detail herein below.

It will be appreciated that designer content is often fragmented. Designers may operate a social account (such as Instagram, Facebook, or TikTok), a video channel (such as YouTube), a Patreon account, and a blog along with additional digital services. Designers typically do not know what their end-users are searching for that may be related to them and they have no control of how content is shown or sorted. These aspects are often determined by a search engine used by the end-users/fans (Google or otherwise) and not by the designer.

Search box handler 84 may enable designers to control and populate their own transitional page search box and have control over what their end-users can search such as what content can be indexed, highlighted, synchronized, or removed. Designers may also control how searched content is ranked and displayed. Search box handler 84 (and analyzer 81) may determine for display what the most searched content is, and track what their end-users are looking for providing a preferred semantic-based preview.

Search box handler 84 may also allow the designer to add and index links when creating a transitional page for display to end-users.

It will be appreciated that the addition may be manual or automatic (for example by using machine learning (ML)) and may enable a designer to add single or multiple links and assign their properties, such as a target URL.

Search box handler 84 may also add an RSS feed or use a 3rd party application programming interface (API) to connect to 3rd party services (e.g., Amazon/Shopify, etc.) to pull a list of links of products, blog posts, music links, podcasts, articles, or videos.

Search box handler 84 may also connect to social networks (Facebook/YouTube/TikTok/Instagram/Snap/LinkedIn/Twitter/Pinterest, etc.) to pull posted content by the designer on other social networks and search the pulled content.

Search box handler 84 may further adjust any search presentation. Different options may be do not show anything, show drop-down with different displays such as drop-down menus for all/recent/top/grossing etc. tags, all/recent/top/grossing etc. coupon codes, all/recent/top/grossing links and all/recent/top/grossing coupons as discussed herein above regarding analyzer 81.

Search box handler 84 may offer the above mentioned search capability for all designers that have implemented a personal search box and have indexed their links. The transitional page search box may be used as a destination website, may search by default on all indexed designer data sources and may allow the search on a specific designer or all indexed designer data sources.

The transitional page search box may also suggest other results based on the end-user searches from other designers of WBS 200 and may suggest results accordingly.

It will be appreciated that promotions may be automatically generated by campaign/coupon determiner 82 which may consider parameters such as the history of an end-user's interactions with a specific designer and the history of end user's interactions with other designers of the WBS. It may also consider promotions that could better serve a designer's current agenda (e.g., monetizing, collecting email addresses, promote an event, promote a service, promote a new product, etc.)

Campaign/coupon determiner 82 (with the help of AI/ML engine 811) may determine any coupons or campaigns etc. that could be placed within the transitional page. It will be appreciated that a coupon may be considered a specific use of a short link. As part of a short link creation process, after adding the shortened URL, the designer may assign a coupon code to a link (and add further information such as a description, call to action (CTA), or image). Sample CTAs could be “continue” or “buy now.” Once the URL has been clicked by an end-user, the dynamic page is displayed with the defined coupon. The end-user may copy the coupon code and continue to the destination.

Campaign/coupon determiner 82 may create the coupon automatically or allow the designer to create it manually. The coupon may be interleaved with auto-generated short/easy-to-remember search keywords which point to the relevant items.

Campaign/coupon determiner 82 may also determine campaigns aimed at campaign managers, social influencers, partners, and large organizations. Thus, transitional page creator 86 may create a “master” pre-roll (or a set of alternating pre-rolls) that can be assigned to different links that were created by different people. Therefore, anytime that a campaign participant shares a link (e.g., a link to a Facebook post she published), the promotion (“pre-roll”) is prompted. If the pre-roll is changed by the campaign manager, campaign/coupon determiner 82 may update the promotion accordingly.

MTIS 80 may include a dashboard that may present (potentially in near real-time) the flow of the system showing the whereabouts of all users, all links, all clicks on the links, statistics of use, and trends. The dashboard may use AI/ML engine 811 to provide other recommendations such as handling abuse of MTIS 80, ways to enlarge revenue etc.

As discussed herein above, input presenter 83 may provide a personalized alternative input mechanism to the regular keyboard used with transitional page creator 86, like the familiar “emoji” keyboard on a mobile device. Input presenter 83 may provide an input mechanism such as a personalized MTIS keyboard, which shows any link, product, video, service, or other entity that was created with the MTIS 80 and is ready to be shared. It will be appreciated that content shown may be personalized using machine learning (via recommender 812), APIs, and other methods, to the last application or platform used (such as Instagram, FB, etc.) or to the last context. Thus, the input mechanism may streamline transitional page creation.

It will be further appreciated that input presenter 83 may dynamically change the presentation of the input mechanism according to the changing context of the designer creations. One of the ways to dynamically change the presentation is by adding snippets of programming code such as JavaScript or other products such as Velo commercially owned by Wix.com. Velo code is further described in U.S. Pat. No. 11,106,860 entitled “Common Database for Live Operation and Testing of a Website, issued Oct. 29, 2024, commonly owned by Applicant and incorporated herein by reference. Velo provides users with the ability to add custom code to their websites using JavaScript. This allows for more extensive customization and the creation of dynamic and interactive features. With Velo, designers can build database-driven web applications, implement custom forms, integrate external APIs, and more. The system may also implement the addition of code snippets or sections using other mechanisms and frameworks by other vendors (i.e., not just Velo), including use of different programming languages and models, and embedding technologies. These may include adding prompts or prompt sections or hints to be used with ML/AI systems (including in particular generative AI systems).

The snippets may be stored in a code snippet library as part of CMS 50. An example of a code snippet output, may be a real time, personalized generated form than can be sent by the designer to his end-users as a price quote that is sent based on chat content or any other relevant context. These snippets may be added by the WBS vendor or by the designer and may be displayed for the designer to use or run when the keyboard is initializing, to be seen and used by the end user. The designer may then be able to choose a snippet by clicking on its icon and running it. The programming code may be able to use APIs to change the UI/UX of the regular designer keyboard and its functionality by adding code for the keyboard callbacks to form the personalized input mechanism, or otherwise using input mechanism customization calls and APIs, thus controlling the input mechanism's behavior.

Input presenter 83 may also allow designers to post custom shortcuts for automating repetitive tasks, boosting productivity and efficiency for their end-users. For example, if an end user requests to book a haircut, the designer can choose a relevant action/experience, modify it, and send it to the end-user as a link that requires payment. Once payment is made by the end-user, a possible automation is triggered. Automation links may also be sent and managed directly through the input mechanism.

It will be appreciated that input presenter 83 may also enable a designer to toggle between his regular keyboard and his personalized input mechanism.

Input presenter 83 may retrieve analyzed designer information from analyzer 81 including past editing sessions and may therefore “understand” (using AI/ML engine 811) the context in which the transitional page is being built and may display a list of entities based on their relevance.

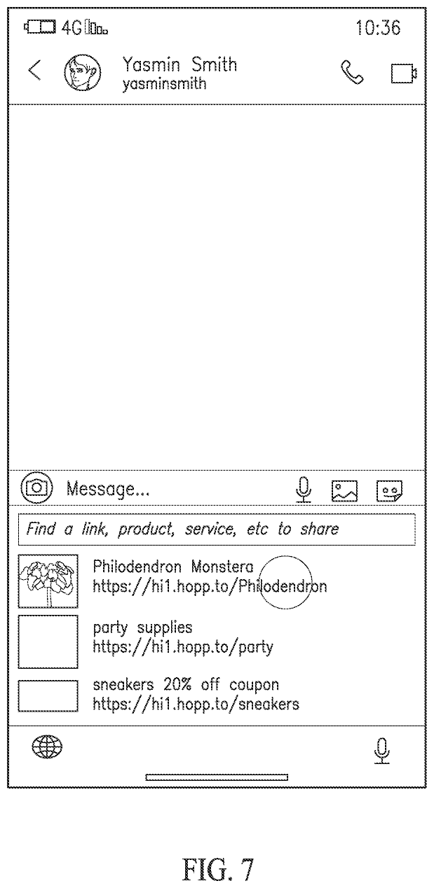

Reference is now made to FIG. 7 which shows a screenshot of an example input mechanism for designer Yasmin Smith based on her designer parameters and her end user parameters. It will be appreciated that when Yasmin opens her regular WBS interface with transitional page creator 86, a personalized input mechanism may be displayed showing past entities (such as products and services) she has previously created. It will be appreciated that input presenter 83 may recognize the current context and present content accordingly. The displayed input mechanism may also have a quick share bar enabling a designer to share content that has been created and indexed.

For example, the designer may share a relevant item (by clicking on the item, or by typing its details). Once it is found, the designer clicks on it, the item is sent as a link with its respective details (as appears in the link preview).

It will be appreciated that a designer may communicate with end-users (emails, text messaging, WhatsApp, any 3^{rd} party messenger) via communicator 87, that have provided any contact details in the past and are stored in CMS 50/database 85. The communication list may include some or all users of MTIS 80 or may use smart targeting. When smart-targeting, contact may be made with specific end users based on their past behaviors with the designer or other designers of the WBS (such as clicked a promotion/purchased a specific product/showed interest in promotion by directly contacting the designer etc.). In this scenario, input presenter 83 may also prompt communicator 87 to display a personalized input mechanism according to the end-user's past interactions and preferences. An AI engine based on frameworks such as TensorFlow (commercially available from tensorflow.org), PyTorch (commercially available from pytorch.org), Generative Pre-trained Transformer (GPT) based UI generation systems (e.g., using ChatGPT commercially from OpenAI Ltd.) and other software libraries for machine learning and artificial intelligence may be used to interpret communications and call any relevant APIs.

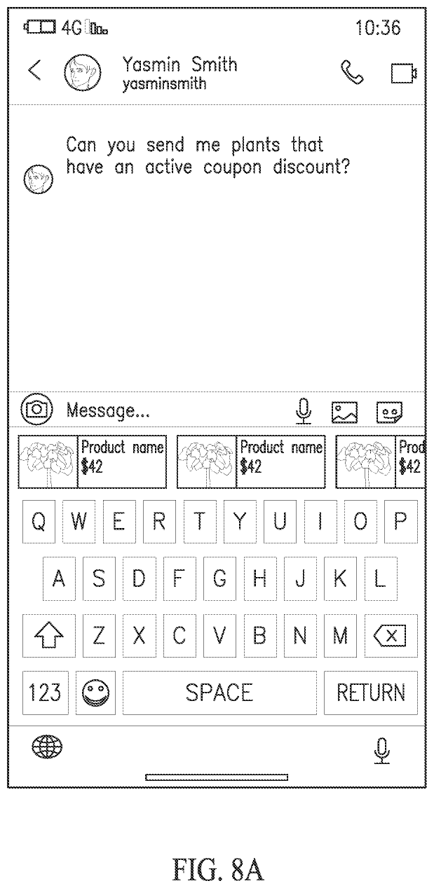

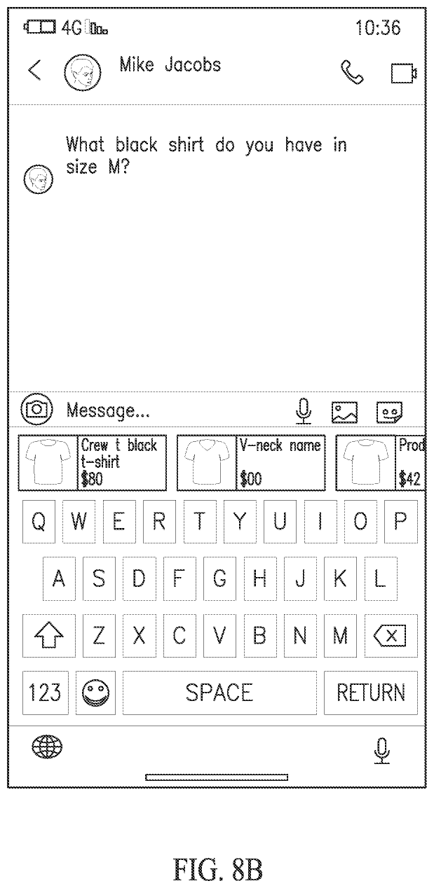

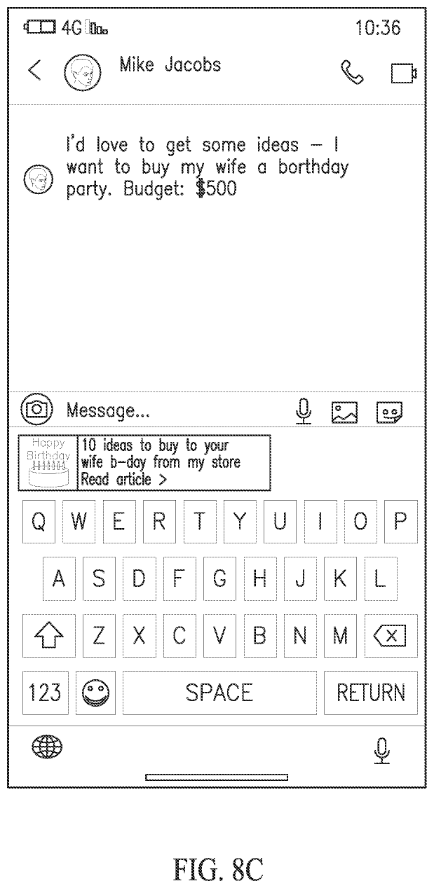

Reference is now made to FIGS. 8A, 8B and 8C which show example scenarios. In FIG. 8A, the end-user is asking for plants that have an active coupon discount. The input mechanism displayed knows which plants are on sale from campaign/coupon handler 82 and presents them with their price. In FIG. 8B, the end-user asks for black shirts in size medium and in FIG. 8C the end-user asks a generalized question and receives an appropriate article as a response. It will be appreciated that the recommendations displayed may all be based on the conversation/communication content and may be provided by recommender 812. In addition to conversational content, input mechanism 83 may also suggest recommendations according to replies, comments, forums, emails etc. It will be appreciated that a designer may review and edit any recommendations before they are sent.

It will be appreciated that communication using communicator 87 may be between human designers and human end users, machine (i.e. automated responses and content instead of the designer) and a human end-user, a human designer and machine and machine to machine.

In an alternative embodiment, input presenter 83 may generate a landing page for presentation to the end-user with the relevant product links, recommendations etc.

Once a transitional page has been created, it may be generated by site generation system 40.

Thus MTIS 80 may be used as a standalone system or in conjunction with a WBS to create a transitional page providing actions, advertisements and searching ability for end-users. MTIS 80 may further make the creation process personalized for the designer by providing him with recommendations and an alternative input mechanism according to his context, history of related entities and artificial intelligence/machine learning.

Unless specifically stated otherwise, as apparent from the preceding discussions, it is appreciated that, throughout the specification, discussions utilizing terms such as “processing,”“computing,”“calculating,”“determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus, when instructed by software may turn the general-purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A website building system (WBS), said system comprising:
at least one processor; and
a mid-transition interaction system running on said at least one processor to enable a designer using said WBS, to build a transitional page; said mid-transition interaction system comprising:
at least one database storing designer parameters and parameters of end-users accessing websites and transitional pages created by said WBS; and
an input presenter to determine a personalized input mechanism to present at least content to said designer according to least said designer parameters and said parameters of end-users for use with at least one of:
a transitional page creator to enable said designer to build said transitional page; and
a communicator enabling communication between said designer and at least one end-user.

2. The system according to claim 1 wherein said input presenter dynamically changes the presentation of said personalized input mechanism according to changing context of at least one of: said transitional page and said communication.

3. The system according to claim 1 and wherein said designer parameters comprise at least one of: designer editing history, designer search history, designer websites and previously created and shared links, products, videos and services.

4. The system according to claim 1 wherein said input presenter enables toggling between the display of said personalized input mechanism and display of the regular input mechanism of said designer.

5. The system according to claim 1 and wherein said parameters of end-users comprises usage behavior of end-users using said websites and transitional pages.

6. The system according to claim 1 and wherein said at least content comprises at least one of: a link, a product, a video, a service, other entities previously created by said designer and assets and resources external and internal to said WBS.

7. The system according to claim 1 and wherein said mid-transition interaction system further comprises:
an analyzer to at least analyze designer parameters and parameters of end-users to provide recommendations for content for said transitional page and said communicator using at least one of: heuristics, statistical analysis, artificial intelligence and training a machine learning model or a combination thereof to determine said recommendations;
a campaign/coupon handler to determine campaigns and coupons for display on said transitional page according to said analyzer and systems external to said WBS; and
a search box handler to determine what content can be presented to said at least one end-user of said transitional page for end-user searching purposes.

8. The system according to claim 7, wherein said analyzer comprises:
an AI/ML (artificial intelligence/machine learning) engine to at least provide said artificial intelligence and said training a one machine learning model; and
a recommender to make recommendations to said input presenter according to the output of said AI/ML engine.

9. The system according to claim 1 wherein said personalized input mechanism is a keyboard.

10. The system of claim 1 wherein said personalized input mechanism is controlled by predefined snippets of programming code defining at least one of: previously displayed links, products, videos, service or entities by said designer, an API use to change the UI for said designer or said at least one end-user, custom code for use by said designer, addition of mechanisms and frameworks external to said WBS for use, prompts and use of a generative AI (artificial intelligence system).

11. The system according to claim 10 wherein said snippets are pre-defined by said WBS vendor or by said designer and are displayed for selection by said designer or end-user to run when said personalized input mechanism is initializing.

12. A system, the system comprising:
at least one processor; and
a unit running on said at least one processor to enable a designer to build a transitional page; said unit comprising:
a transitional page creator to enable said designer to create said transitional page comprising at least one feature according to recommendations and designer added links; and
an input presenter to determine and present a personalized input mechanism for said designer when using said transitional page creator according to at least one of:
previously created and shared links, products, videos and services by said designer; and
wherein said input presenter dynamically changes the presentation of said personalized input mechanism according to changing context of said transitional page.

13. A method for a website building system (WBS), said method comprising:
enabling a designer of said WBS to build a transitional page; said enabling a designer of said WBS to build a transitional page comprising:
storing in at least one database designer parameters and parameters of end-users accessing websites and transitional pages created by said WBS; and
determining a personalized input mechanism to present at least content to said designer according to least said designer parameters and said parameters of end-users for use with at least one of:
enabling said designer to build said transitional page; and
enabling communication between said designer and at least one end-user.

14. The method according to claim 13 wherein said determining a personalized input mechanism dynamically changes the presentation of said personalized input mechanism according to changing context of at least one of: said transitional page and said communication.

15. The method according to claim 13 and wherein said designer parameters comprise at least one of: designer editing history, designer search history, designer websites and previously created and shared links, products, videos and services.

16. The method according to claim 13 wherein said determining a personalized input mechanism enables toggling between the display of said personalized input mechanism and display of the regular input mechanism of said designer.

17. The method according to claim 13 and wherein said parameters of end-users comprises usage behavior of end-users using said websites and transitional pages.

18. The method according to claim 13 and wherein said at least content comprises at least one of: a link, a product, a video, a service, other entities previously created by said designer and assets and resources external and internal to said WBS.

19. The method according to claim 13 and wherein said enabling a designer to build a transitional page further comprises:
to at least analyzing designer parameters and parameters of end-users to provide recommendations for content for said transitional page and said communicator using at least one of: heuristics, statistical analysis, artificial intelligence and training a machine learning model or a combination thereof to determine said recommendations;
determining campaigns and coupons for display on said transitional page according to said at least analyzing and systems external to said system; and
a search box handler to determine what content can be presented to said at least one end-user of said transitional page for end-user searching purposes.

20. The method according to claim 19, wherein said at least analyzing designer parameters and parameters of end-users comprises:
at least providing said artificial intelligence and said training a machine learning model; and
making recommendations for said determining a personalized input mechanism according to the output of said at least providing artificial intelligence and said training ae machine learning model.

21. The method according to claim 13 wherein said personalized input mechanism is a keyboard.

22. The method according to claim 13 and further comprising controlling said personalized input mechanism using predefined snippets of programming code defining at least one of: previously displayed links, products, videos, service or entities by said designer, an API use to change the UI for said designer or said at least one end-user, custom code for use by said designer, addition of mechanisms and frameworks external to said WBS for use, prompts and use of a generative AI (artificial intelligence system).

23. The method according to claim 22 and further comprising:
pre-defining said snippets; and
displaying said snippets for selection by said designer or end-user to run when said personalized input mechanism is initializing.
